(19) United States
(12) Patent Application Publication
(10) Pub. No.: US 2007/0016356 A1
(43) Pub. Date: Jan. 18, 2007

(54) Device for controlling the internal combustion engine/drive train for a motor vehicle

(75) Inventors: Hartmut Kolb, Ludwigsburg (DE); Mayk Stelter, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/487,398

(22) Filed: Jul. 17, 2006

(30) Foreign Application Priority Data
Jul. 18, 2005 (DE) 10 2005 034 014.8
May 19, 2006 (DE) 10 2006 023 575.4

(51) Int. Cl. G06F 17/00

(52) U.S. Cl. 701/103; 701/104

(57) ABSTRACT

In a device for controlling the internal combustion engine/drive train of a motor vehicle, based on process control variables of a combustion process that are distributed among a plurality of subsystems, an optimization unit stores information for carrying out the combustion process. The optimization unit determines the process control variables of the combustion process as a function of detected state and system variables and of at least one predefined value of a drive unit, and outputs them to the plurality of subsystems via corresponding, defined interface units. Distribution of the combustion process among the plurality of subsystems is carried out as a function of logical and physical requirements.

### BACKGROUND AND SUMMARY OF THE INVENTION

This application claims the priority of German patent documents 10 2005 034 014.8 filed Jul. 18, 2005 and 10 2006 023 575.4, filed May 19, 2006, the disclosures of which are expressly incorporated by reference herein.

The invention relates to a device for controlling the internal combustion engine/drive train of a motor vehicle.

A functional core of current software for engine control units is based on a torque structure, in which torque requirements are implemented individually by intervention in the ignition angle, and by influencing the formation of a mixture. A coordinated unified torque (which takes into account, for example, a driver setpoint torque, an engine setpoint torque, a transmission setpoint torque, a brake setpoint torque, an air conditioning compressor torque, etc.) is converted by a drive unit directly into setpoint values for actuators and actuating elements which control, for example, an air mass flow rate, an ignition angle, an injection quantity, an injection angle, a swirl valve etc., to achieve torque control. In order to implement such torque control, reverse calculation of the current torque is performed in the torque path, in order to perform a setpoint/actual value reconciliation.

German patent document DE 100 44 319 A1 discloses an electronic system for a vehicle and a system layer for operating functions. The electronic system comprises first components for carrying out control tasks in operational sequences, and second components which coordinate interaction among the components in order to carry out control tasks. The first components carry out the control tasks using operating functions and basic functions. The electronic system is designed with the basic functions combined in a basic layer, and a system layer which comprises at least two of the second components and is supported on the basic functions. The system layer has at least one open interface with the operating functions being provided, and connects the basic functions to any operating functions in such a way that the operating functions can be integrated and/or used in a modular fashion.

One object of the invention is to provide a device for controlling the internal combustion engine/drive train of a motor vehicle, which permits complex functional content to be distributed and which permits development work to be apportioned.

This and other objects and advantages are achieved by the device for controlling the internal combustion engine/drive train of a motor vehicle according to the invention, which coordinates process control variables, distributed among a plurality of subsystems, of a combustion process. The device comprises an optimization unit, which stores information for carrying out the combustion process, and which determines the process control variables of the combustion process as a function of detected state and system variables and of at least one predefined value of a drive unit. The process control variables thus determined are output to the plurality of subsystems via corresponding, defined interface units. The distribution of the combustion process among the plurality of subsystems is carried out as a function of logical and/or physical requirements.

The plurality of subsystems advantageously permit control of the internal combustion engine/drive train to be partitioned into individual technology modules that can be controlled by the optimization unit in their entirety via the interface units. In addition, the device according to the invention advantageously permits the individual technology modules to be developed an apportionment of work among different development entities, without undesired dissemination of know how. The developed individual technologies can advantageously be used again for other projects. In addition, the device according to the invention permits a high degree of transparency of the individual areas and easily comprehensible control of the entire process.

In one embodiment of the invention, the subsystems comprise, for example, a fuel metering system, an ignition system, an air metering system, an inert gas metering system and/or at least one process control system. The air metering system carries out, for example, fully variable valve control (i.e., in such a way that the valves of the internal combustion engine can each be individually opened and closed according to stroke and phase). A first process control system carries out, for example, engine-internal center of gravity control and engine-internal medium pressure control. A second process control system performs, for example, a variable compression process and/or a high-pressure supercharging process.

The physical requirements are implemented in a logic module, a microprocessor system or in individual distributed software modules which are each present in the system and interact. The abovementioned functions are preferably implemented in algorithms or function models which can in turn be composed of differential equations. In this context, it is possible to use measured variables which originate from a physical model of the real vehicle. These measured variables are then used to perform closed-loop or open-loop control of the system.

In a further embodiment of the device according to the invention, the process control variables comprise, for example, an efficiency level, a compression level, a charge pressure and a combustion control process. The state and system variables comprise, for example, engine speed, cooling water temperature, ambient pressure and exhaust gas temperature. The at least one predefined value of the drive unit comprises, for example, a driver setpoint torque, an engine setpoint torque, a transmission setpoint torque and/or a brake setpoint torque. The optimization unit coordinates the process control variables as a function of the setpoint torques, which are conditioned and made available by the drive unit, and as a function of the state and system variables. In addition, the optimization unit predefines the setpoint configuration of the subsystems for each point in time during the control of the internal combustion engine/drive train.

In a further embodiment of the device according to the invention, the definition of the interface units comprises in each case an electrical rating, i.e., a specification of the “physical layer”, a communications protocol and a specification of data to be transmitted, for example data format, resolution, data rate etc. The definition of the interfaces permits different system units to be operated at the described interfaces using the same functionality, making the components interchangeable without changing the structure of the existing system.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic block diagram of a device for controlling the internal combustion engine/drive train for a motor vehicle;

FIG. 2 is a block diagram illustrating the method of operation of an optimization unit illustrated in FIG. 1; and

FIG. 3 is a block diagram of an exemplary embodiment of a device for controlling the internal combustion engine/drive train.

### DETAILED DESCRIPTION OF THE DRAWINGS

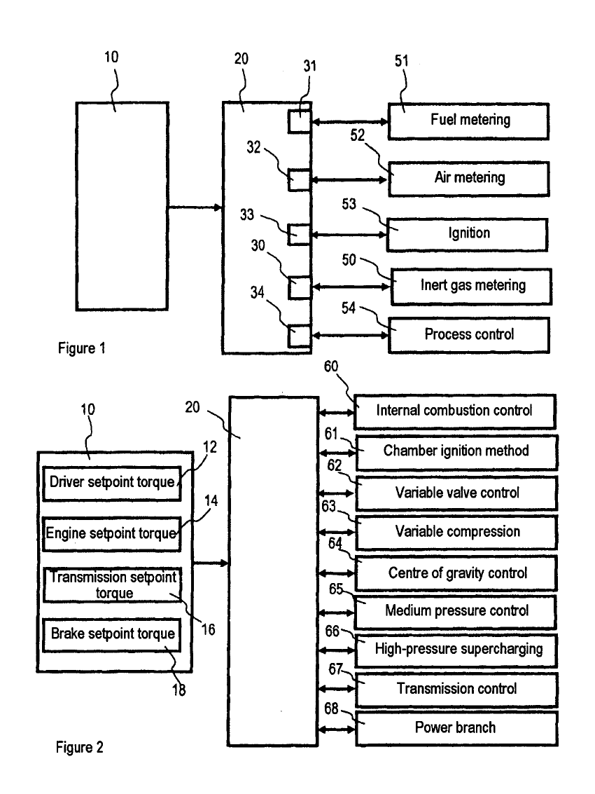

As is apparent from FIG. 1, a device according to the invention for controlling the internal combustion engine/drive train for a motor vehicle comprises a drive unit 10, an optimization unit 20 with a plurality of defined interface units 30, 31, 32, 33 and 34 and a plurality of subsystems 50, 51, 52, 53 and 54. Information relating to the execution of a combustion process is stored in the optimization unit 20. The latter determines process control variables of the combustion process as a function of at least one predefined value of the drive unit 10 and of detected state and system variables, and outputs the process control variables to the plurality of subsystems 50, 51, 52, 53 and 54 via the correspondingly defined interface units 30, 31, 32, 33 and 34. The distribution of the combustion process among the plurality of subsystems 50, 51, 52, 53 and 54 is carried out as a function of physical requirements. The illustrated subsystems 50-54 comprise, for example, a fuel metering system 51, an ignition system 53, an air metering system 52, an inert gas metering system 50 and a process control system 54.

As is apparent from FIG. 2, the optimization unit 20 coordinates the process control variables (for example for the purpose of setting the efficiency level (η), compression level (ε), charge pressure, and for controlling combustion) which are used for activating, carrying out and/or controlling functions. The functions comprise, for example, an internal combustion control 60, a chamber ignition method 61, a variable valve control (EHVS) 62, a variable compression function (NAMI) 63, a center of gravity control 64, a medium pressure control 65, a high-pressure supercharging function 66, a model-based transmission control 67 and a power branch function 68 for an electric additional drive or a hybrid drive. The optimization unit 20 outputs the process control variables to the subsystems 50, 51, 52, 53 and 54 as a function of at least one predefined value of the drive unit 10 and of detected state and system variables. The at least one predefined value of the drive unit 10 comprises, for example, a driver setpoint torque 12, an engine setpoint torque 14, a transmission setpoint torque 16 and a brake setpoint torque 18 which can be conditioned and combined by the drive unit 10 before being output to the optimization unit 20. In order to distribute and/or partition the control of the internal combustion engine/drive train, the optimization unit 20 evaluates the state and system variables such as, for example, engine speed, engine oil temperature, cooling water temperature, ambient pressure, exhaust gas temperature etc. and predefines the setpoint configuration for the subsystems 50, 51, 52, 53 and 54 for each point in time.

Depending on the requirements, it is possible to integrate a different number of subsystems 50, 51, 52, 53 and 54. This is carried out by means of a precise interface definition which, in addition to the transmission medium and its specifications (ETK, RS232, CAN etc.), also relates to the description of the setpoint values and actual values which comprises the data format, resolution, data rate etc. The definition of the interfaces permits different subsystems 50, 51, 52, 53 and 54 to be operated at the described interface units 30, 31, 32, 33 and 34 using the same functionality, making the components interchangeable without changing the structure of the existing system. In addition, the individual subsystems 50, 51, 52, 53 and 54 are closed off from one another by means of this structure.

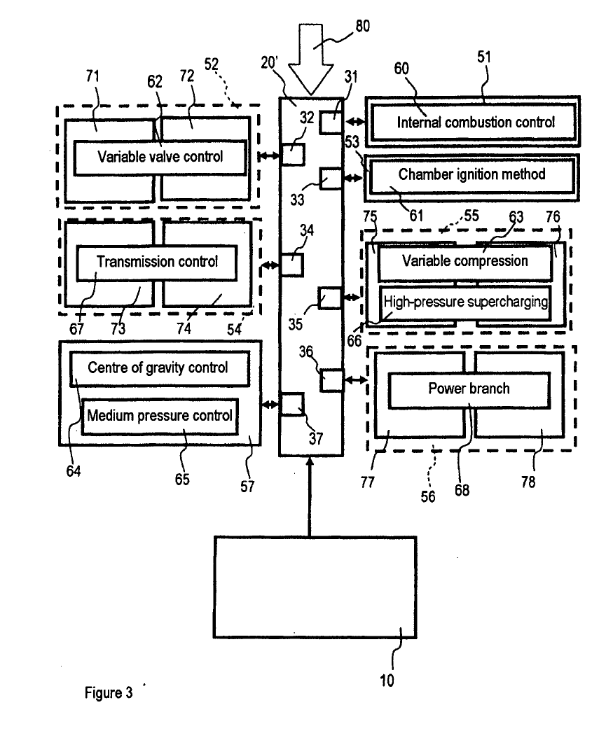

FIG. 3 shows an embodiment of the device according to the invention, which comprises a drive unit 10, an optimization unit 20′ with a plurality of defined interface units 31, 32, 33, 34, 35, 36 and 37, and a plurality of subsystems 51, 52, 53, 54, 55, 56 and 57. Information relating to the execution of the combustion process is stored in the optimization unit 20′, which communicates, via an interface unit 31, with a fuel metering system 51 that carries out, for example, the “internal combustion control” function 60. Via an interface unit 32, the optimization unit 20′ communicates with an air metering system 52 (illustrated by dashed lines) which, in the illustrated embodiment, comprises two control units 71, 72 for carrying out the “variable valve control” function 62.

Via an interface unit 33, the optimization unit 20′ communicates with an ignition system 53 which carries out, for example, the “chamber ignition method” function 61. Via an interface unit 34, the optimization unit 20′ communicates with a process control system 54 (illustrated by dashed lines) which comprises two control units 73, 74 for carrying out the “transmission control” function 67 in the illustrated exemplary embodiment. Via an interface unit 35, the optimization unit 20′ communicates with a further process control system 55 (illustrated by dashed lines) which comprises two control units 75, 76 for carrying out the “variable compression” function 63 and “high-pressure supercharging” function 66 in the illustrated exemplary embodiment. Via an interface unit 35, the optimization unit 20′ communicates with a further process control system 56 (illustrated by dashed lines) which comprises two control units 77, 78 for carrying out the “power branch” function 68 in the illustrated exemplary embodiment. Via an interface unit 37, the optimization unit 20′ communicates with a further process control system 57 which carries out, for example, the engine-internal “center of gravity control” function 64 and engine-internal “medium pressure control” function 65.

In a manner analogous to the description of FIG. 1, the optimization unit 20′ determines the process control variables of the combustion process as a function of at least one predefined value of the drive unit 10 and of detected state and system variables and outputs the process control variables to the subsystems 50, 51, 52, 53, 54, 55, 56 and 57 via the correspondingly defined interface units 30, 31, 32, 33, 34, 35, 36 and 37. In addition to the described functions, the described subsystems 50, 51, 52, 53, 54, 55, 56 and 57 carry out basic functions such as the reading out of sensor signals, actuation and setting of actuating elements and/or actuators and interrogation of current positions of the actuating elements and/or actuators.

The subsystems 51, 52, 53, 54, 55, 56 and 57 and the control units 71, 72, 73, 74, 75, 76, 77 and 78 of the subsystems 52, 54, 56 and 57 can relate to completely developed units, for example, for series-production use in a motor vehicle, or so-called rapid system prototyping control units which can be used for the development and/or optimization of the control of the internal combustion engine/drive train in a motor vehicle. This means that the device according to the invention can be used both in a series-production motor vehicle and for developing and optimizing motor vehicles. In addition, various combinations may occur. For example, subsystems 51, 53, 55 and 56 may be completely developed series-production units, and the subsystems 52, 54 and 57 can relate to units which are not yet completely developed. Within the subsystems 52 and 54, the control units 72 and 73 can relate to series-production units which are already completely developed or are slightly modified, and the control units 71 and 74 can be rapid system prototyping control units.

The device according to the invention for controlling the internal combustion engine/drive train advantageously permits partitioning into discrete individual technology modules and unified process control via defined interface units. In addition, the device according to the invention permits the individual technology modules to be developed by apportioning work (simultaneous engineering) by a plurality of development parties, without undesired dissemination of know how. The optimization unit can be implemented, for example, as a software module in a control unit and therefore affords the possibility of storing independent combustion strategies in an engine control unit.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Apparatus for controlling an internal combustion engine/drive train of a motor vehicle based on process control variables of a combustion process, that are distributed among a plurality of subsystems wherein:
an optimization unit stores information for carrying out the combustion process;
the optimization unit determines the process control variables of the combustion process as a function of detected state and system variables and of at least one predefined value of a drive unit; and outputs said process control variables to the plurality of subsystems via corresponding, defined interface units; and
distribution of the combustion process among the plurality of subsystems is carried out as a function of physical requirements.

2. The apparatus according to claim 1, wherein the subsystems comprise at least one of a fuel metering system, an ignition system, an air metering system, an inert gas metering system and a process control system.

3. The apparatus according to claim 2, wherein the air metering system carries out fully variable valve control.

4. The apparatus according to claim 2, wherein a first process control system carries out engine-internal center of gravity control and engine-internal medium pressure control.

5. The apparatus according to claim 4, wherein a second process control system performs a variable compression process and/or a high-pressure supercharging process.

6. The apparatus according to claim 1, wherein the process control variables comprise an efficiency level, a compression level, a charge pressure and a combustion control process.

7. The apparatus according to claim 1, wherein the state and system variables comprise an engine speed, a cooling water temperature, an ambient pressure and an exhaust gas temperature.

8. The apparatus according to claim 1, wherein the at least one predefined value of the drive unit comprises at least one of a driver setpoint torque, engine setpoint torque, a transmission setpoint torque and a brake setpoint torque.

9. The apparatus according to claim 1, wherein the definition of the interface units comprises in each case an electrical rating, a communications protocol and a specification of data to be transmitted.
